(19) United States
(12) Patent Application Publication
(10) Pub. No.: US 2007/0032122 A1
(43) Pub. Date: Feb. 8, 2007

(54) Electronic device with USB storage card

(75) Inventor: Hank Wang, Hsin Chu (TW)

Correspondence Address: BACON & THOMAS, PLLC, 625 SLATERS LANE, FOURTH FLOOR, ALEXANDRIA, VA, 22314, US

(73) Assignee: 3 VIEW TECHNOLOGY CO., LTD, Hsin Chu (TW)

(21) Appl. No.: 11/471,496

(22) Filed: Jun. 21, 2006

(30) Foreign Application Priority Data
Aug. 3, 2005 (TW) 094213278
Jan. 18, 2006 (TW) 095201147

(51) Int. Cl. H01R 13/64; G06F 12/00

(52) U.S. Cl. 439/374; 711/115

(57) ABSTRACT

An electronic device with a USB storage card disposed therein is disclosed. The electronic device comprises a containing space, a first connector disposed in the containing space, and a USB storage card disposed in the containing space and electrically coupled to the electronic device through the first connector for accessing files in the USB storage card. Therefore the inconvenience and the influence on the structure of the storage card caused by changing the storage card frequently can be avoided. Meanwhile, the risk of losing the storage card is also prevented and the trend of miniaturizing the electronic device and increasing the capacity of the storage card can be conformed by the design of the present invention.

### FIELD OF THE INVENTION

The present invention relates to an electronic device, and more particularly to an electronic device for a USB storage card to be applied thereto.

### BACKGROUND OF THE INVENTION

With the progress of the digital technology, many electronic devices, especially portable electronic devices, such as mobile phone, palm computer, notebook computer, or digital camera, have multi-functions of file accessing, network communicating, digital photographing and entertaining, so as to satisfy the requirements of the consumers. Since the storage capacity of the portable electronic device itself is limited, it needs an additional storage card for storing the movie, music, animation, or image files.

However, with the miniaturization and the multi-function requirements of the electronic device, the volume of the memory card tends to be reduced and the storage capacity thereof is increased. Though the common memory cards, such as compact flash card (CF card), multimedia memory card (MMC card), secure digital card (SD card), are widely used nowadays, the volume and the transmission speed of these conventional memory cards cannot meet the user's requirement, since it needs more than one memory card to store the files and takes much time to download these files in the memory card to the computer. Therefore another new memory card named USB storage card is provided recently.

Please refer to FIG. 1, which is a schematic diagram showing a USB storage card. As shown in FIG. 1, the USB storage card 10 is substantially a rectangular-shaped electronic card, each of the four sides of the USB storage card 10 has a set of contact pads 11 to avoid being assembled incorrectly, and each set of the contact pads 11 has five pins 111, which is one more than the conventional USB port. The additional fifth pin can not only enhance the function of the USB storage card 10, such as extending the storage capacity, lowering the output power or accelerating the transmission speed, but also be provided for transmitting other signal.

Therefore it is necessary to provide an electronic device for the USB storage card to be disposed therein and promoting the application of the USB storage card.

### SUMMARY OF THE INVENTION

An object of the present invention is to provide an electronic device with a USB storage card disposed therein for storing the files to the USB storage card or downloading the files from the USB storage card, so as to promote the application of the USB storage card. Meanwhile, the structural damage caused by inserting or pulling out the USB storage card frequently can also be avoided with the design of the present invention.

According to an aspect of the present invention, an electronic device with the USB storage card is provided. The electronic device comprises a containing space, a first connector disposed in the containing space, and a USB storage card disposed in the containing space and electrically coupled to the electronic device through the first connector for accessing files in the USB storage card or storing files to the USB storage card.

In an embodiment, the containing space is disposed inside the electronic device and covered by a portion of the electronic device.

In an embodiment, the containing space is a slot disposed on the peripheral of the electronic device for the USB storage card to be inserted therein.

In an embodiment, the USB storage card comprises at least a set of contact pad with a plurality of pins for connecting to the first connector.

In an embodiment, the first connector comprises a plurality of conducting terminals for connecting to the USB storage card, wherein the conducting terminals are conducting pieces or conducting protrusions.

In an embodiment, the electronic device is a portable electronic device, such as a mobile phone, a palm computer, a notebook computer, a personal digital assistant, or a digital camera.

In an embodiment, the electronic device is a desktop computer.

In an embodiment, the containing space further comprises a fixing device for securing the USB storage card in the containing space.

In an embodiment, the electronic device further comprises a second connector for connecting to a smart card, such as a subscriber identity module card (SIM card).

According to an aspect of the present invention, an electronic device with the USB storage card is provided. The electronic device comprises a containing space and a USB storage card inserted in the containing space for storing files to the USB storage card or accessing files in the USB storage card.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram showing a USB storage card;

FIGS. 2a-2c are schematic diagrams showing the USB storage card disposed inside the electronic device and covered by a portion of the electronic device; and

FIGS. 3a-3b are schematic diagrams showing the USB storage card disposed in the slot on the peripheral of the electronic device.

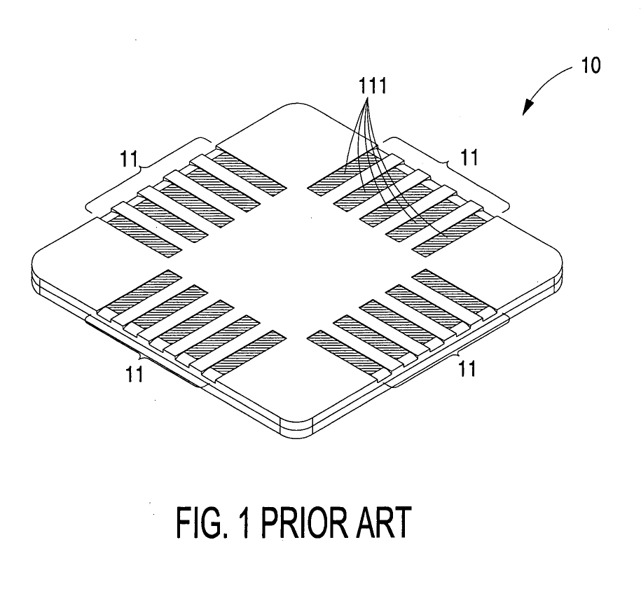

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

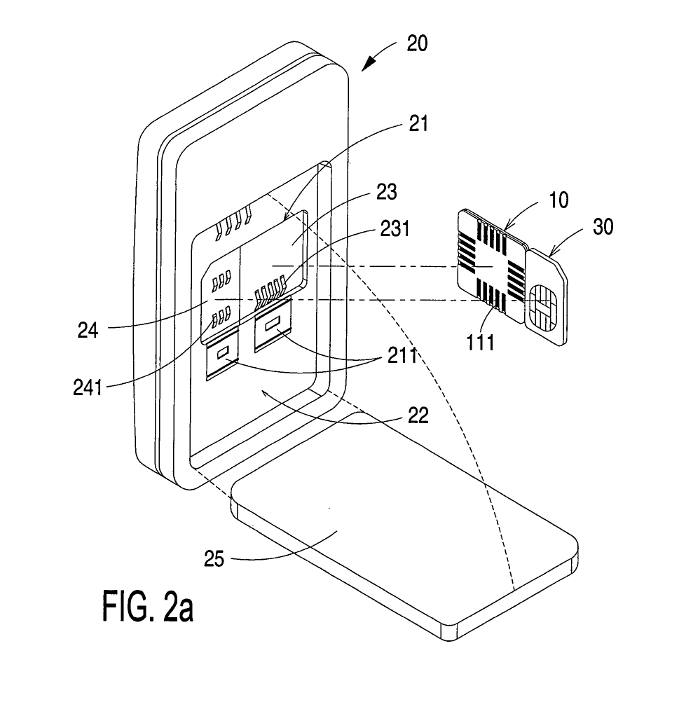

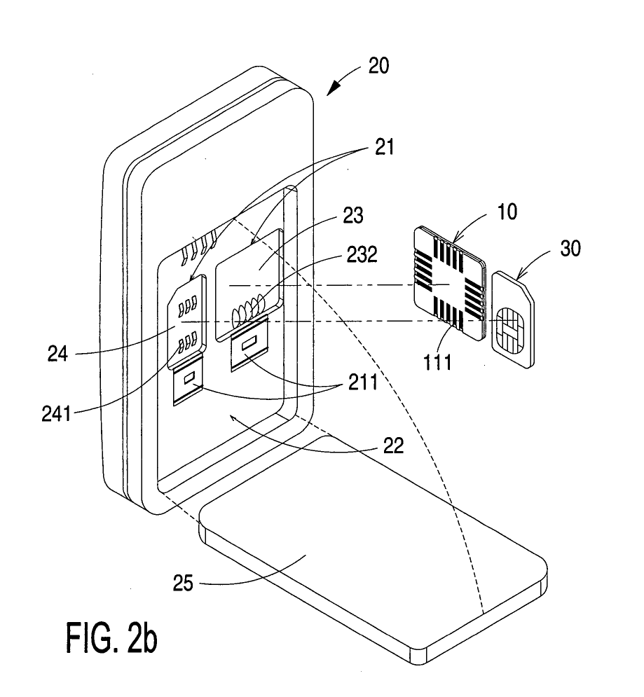

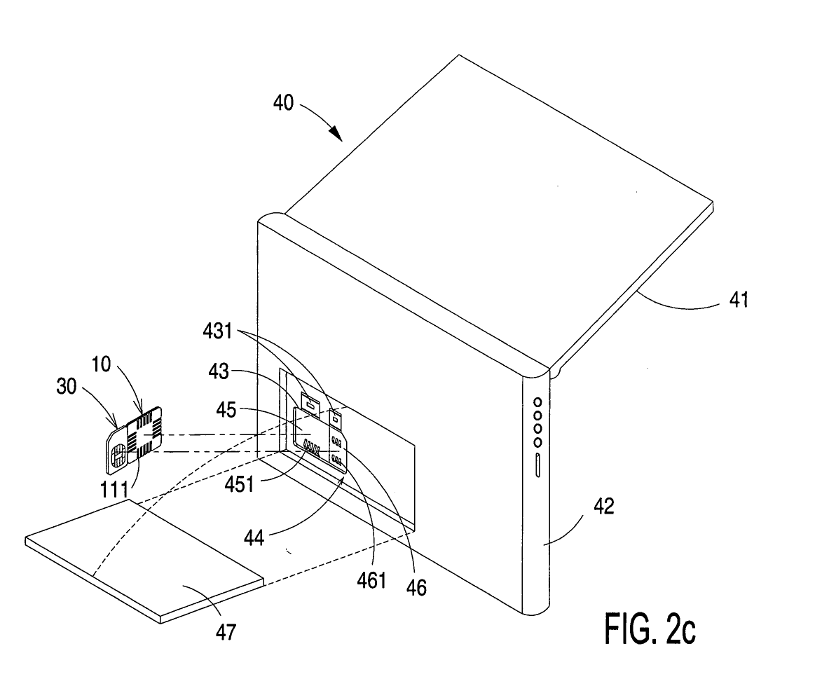

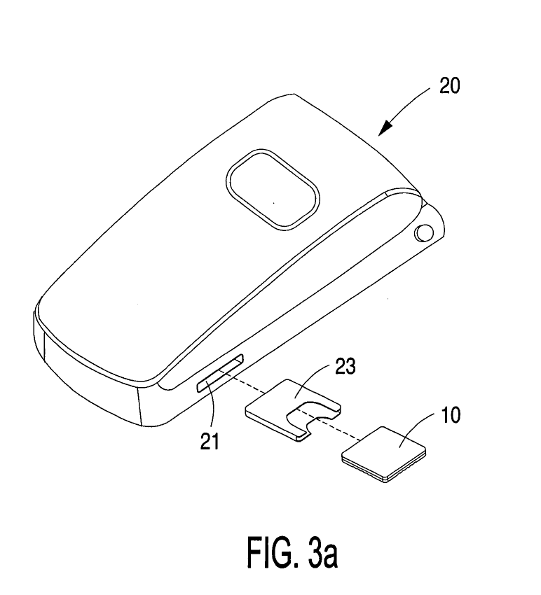

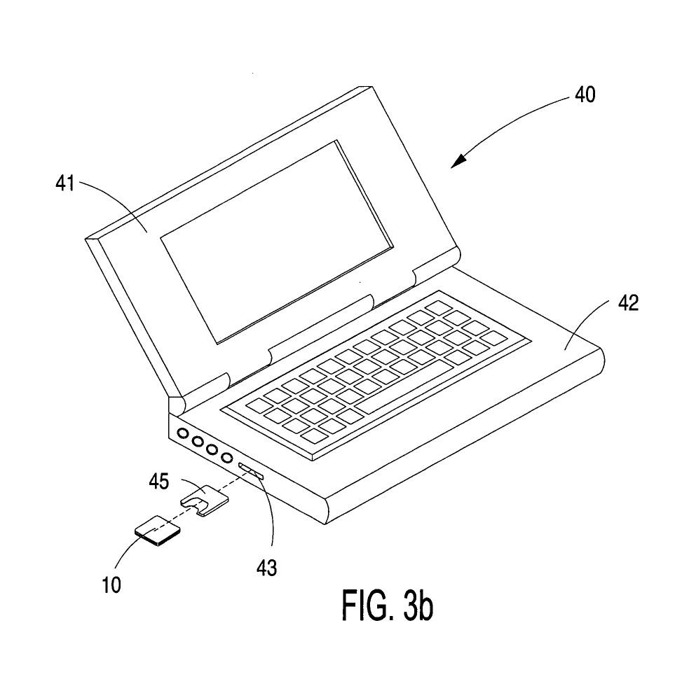

With the development of technology, the electronic files tend to diversification and complication, hence the storage capacity and transmission speed of the conventional storage card cannot meet the requirement. The USB storage card can be stylized and has a large storage capacity and a high transmission speed and thus the electronic devices are designed for the application of the USB storage card. The USB storage card can be not only disposed inside the electronic device and covered by a portion of the electronic device as shown in FIGS. 2a-2c, but also disposed in a slot on the peripheral of the electronic device as shown in FIGS. 3a-3b.

As shown in FIG. 2a, in the first embodiment of the present invention, the electronic device is a mobile phone 20. The mobile phone 20 comprises a containing space 21, which is an indentation for receiving the USB storage card 10 and/or other small card, such as a smart card 30, but not limited thereto. The containing space 21 is disposed in an inner space 22 of the mobile phone 20 and covered by a portion of the mobile phone 20, such as a back cover 25, but not limited thereto. In other words, the back cover 25 can be replaced by a battery (not shown) or other portion of the mobile phone 20. Hence the USB storage card 10 and the smart card 30 are built in the mobile phone 20 and isolated from the external surrounding, so as to avoid the defects, such as the structural damage or the loss of the USB storage card and the small card, of inserting or pulling out the USB storage card 10 or the smart card 30 frequently.

Please refer to FIG. 2a again; the mobile phone 20 further comprises a first connector 23 disposed in the containing space 21 and connected to the circuit board (not shown) inside the mobile phone 20. The first connector 23 has five conducting terminals 231; in this embodiment, the conducting terminals 231 are conducting pieces corresponding to the pins 111 of the USB storage card 10. While the USB storage card 10 is disposed in the containing space 21, the pins 111 of USB storage card 10 are electrically coupled to the circuit board of the mobile phone 20 through the conducting terminals 231 of the first connector 23, therefore the files of photographs or the videos can be stored in the USB storage card 10 and operated directly by the mobile phone 20.

In addition, the mobile phone 20 comprises a second connector 24 with plural conducting terminals 241 for other electronic card to be electrically coupled to the circuit board of the mobile phone 20. In this embodiment, the first connector 23 and the second connector 24 are disposed abreast, and the electronic card is a smart card 30, such as a subscriber identity module card (SIM card), for recording the information of the mobile phone 20. For securing the USB storage card 10 or the smart card 30 in the containing space 21 firmly, the containing space 21 further comprises a fixing device 211, so as to avoid the situation of unable to access files caused by the loosened USB storage card 10 and the smart card 30. Of course, any design for firmly securing the USB storage card 10 and the smart card 30 in the containing space 21 can be used as the fixing device 211 of the present invention.

Please refer to FIG. 2b, which is a schematic diagram showing the USB storage card disposed inside the electronic device and covered by a portion of the electronic device according to the second embodiment of the present invention. In the second embodiment, the containing space 21, the fixing device 211, and their connecting relation with the USB storage card 10 and the smart card 30 are the same as those of the first embodiment shown in FIG. 2a; thus it is not redundantly described here. As shown in FIG. 2b, the conducting terminals 232 of the first connector 23 are conducting protrusions. Similarly, the conducting terminals 232 are corresponding to the pins 111 of the USB storage card 10; hence the pins 111 of the USB storage card 10 are electrically coupled to the circuit board (not shown) of the mobile phone 20 through the conducting terminals 232 of the first connector 23, so as to access the files. In addition, unlike the first embodiment shown in FIG. 2a, the first connector 23 and the second connector 24 are disposed separately. In other words, the positions of the first connector 23 and the second connector 24 are not limited, and the functions for electrically coupling to the USB storage card 10 and the smart card 30 are not affected.

Of course, the electronic device for the application of the USB storage card can be any electronic device other than the mobile phone. As shown in FIG. 2c, the electronic device is a notebook computer 40 comprises a monitor 41 and a host 42, wherein the host 42 comprises a motherboard (not shown) therein and a containing space 43. The containing space 43 is an indentation disposed in an inner space 44 of the host 42 for receiving the USB storage card 10 and/or other electronic card, such as the smart card 30, but not limited thereto. In this embodiment, the inner space 44 is a space for installing a portion of the notebook computer 40, such as the battery 47, but not limited thereto. Therefore the USB storage card 10 and the smart card 30 are disposed in the containing space 43 and isolated from the external surrounding of the notebook computer 40 by the battery 47, so as to avoid the defects and inconvenience of inserting or pulling out the USB storage card 10 and the smart card 30 frequently. It is to be understood that the battery 47 can be replaced by a back cover (not shown) or other portions of the notebook computer 40.

Similarly, the containing space 43 of the notebook computer 40 comprises a first connector 45 and a second connector 46 with plural conducting terminals 451 and 461 respectively for the USB storage card 10 and the smart card 30 to be electrically coupled to the motherboard (not shown) in the host 42. However, the shape of the conducting terminal 451 is not limited, which can be the conducting piece shown in FIG. 2c or the conducting protrusion shown in FIG. 2b. Hence the USB storage card 10 can be operated by the operation system driven by the host 42 controlled directly by the user, so as to download the files in the USB storage card 10 to the storage media (not shown) in the host 42 or record the information of the notebook computer 40 through the smart card 30. In addition, the containing space 43 further comprises a fixing device 431 for firmly securing the USB storage card 10 and the smart card 30 therein, and any design for securing the USB storage card 10 and the smart card 30 can be used as the fixing device 431 of the present invention.

Of course, the applications of the USB storage card are not limited to the foregoing embodiments. FIGS. 3a-3b are schematic diagrams showing the USB storage card disposed in the slot on the peripheral of the electronic device. As shown in FIG. 3a, the electronic device is a mobile phone 20 comprising a containing space 21 on the peripheral of the mobile phone 20, wherein the containing space 21 is a slot for the USB storage card 10 to be inserted therein. The containing space 21 further comprises a first connector 23 with plural conducting terminals (as shown in FIGS. 2a-2c) for the USB storage card 10 to be electrically coupled to the circuit board (not shown) inside the mobile phone 20 while the USB storage card 10 is inserted in the containing space 21. Hence the files, such as the photographs, the videos, and so on, can be stored in the USB storage card 10 in the mobile phone 20.

The files in the electronic device can be stored to the USB storage card as described in the foregoing embodiment, and of course, the files in the USB storage card 10 can be downloaded to the electronic device. As shown in FIG. 3b, the electronic device is a notebook computer 40 comprising a monitor 41 and a host 42, wherein the host 42 has a motherboard therein and a containing space 43 disposed on the peripheral thereof. The containing space 43 is a slot for the USB storage card 10 to be inserted therein and comprises a first connector 45 with plural conducting terminals (as shown in FIGS. 2a-2c) for the USB storage card 10 to be electrically coupled to the motherboard in the host 42 of the notebook computer 40. When the USB storage card 10 is inserted in the containing space 43, the user can use the operation system driven by the motherboard in the host 42 of the notebook computer 40 for downloading the files in the USB storage card 10 to the storage media (not shown), such as a hard disk, or store the files to the USB storage card 10 through the first connector 45.

Of course, a second connector for other electronic card, such as a smart card, can be disposed in the electronic devices shown in FIGS. 3a-3b. Besides, the electronic device for the application of the USB storage card can be a digital camera, a palm computer, a personal digital assistant, a desktop computer or the portable electronic device other than the mobile phone 20 and the notebook computer 40 described in the foregoing embodiments, and it is to be understood that the containing space, the first and second connectors and their connecting relation with the USB storage card and the smart card are similar to those in the foregoing embodiments.

To sum up, the USB storage card can be not only disposed in the containing space inside the electronic device and covered by a portion of the electronic device, but also inserted in the slot on the peripheral of the electronic device. Meanwhile, the USB storage card is electrically coupled to the inner circuit of the electronic device through the first connector, so as to access the files in the USB storage card. Moreover, because the USB storage card is disposed in the electronic device, the volume of the electronic device is not being affected; therefore the miniaturization trend of the electronic device can be satisfied. Besides, the defects, such as the risk of losing the storage card or the structural damage of the storage card, caused by frequently changing the storage card can be avoided owing to the large storage capacity and the high transmission speed of the USB storage card.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic device comprising:
a containing space;
a first connector disposed in said containing space; and
a USB storage card disposed in said containing space and electrically coupled to said electronic device through said first connector for accessing files in said USB storage card or storing files to said USB storage card.

2. The electronic device according to claim 1 wherein said containing space is disposed inside said electronic device and covered by a portion of said electronic device.

3. The electronic device according to claim 1 wherein said containing space is a slot disposed on the peripheral of said electronic device for said USB storage card to be inserted therein.

4. The electronic device according to claim 1 wherein said USB storage card comprises at least a set of contact pad.

5. The electronic device according to claim 4 wherein said set of contact pad comprises a plurality of pins for connecting to said first connector.

6. The electronic device according to claim 1 wherein said first connector comprises a plurality of conducting terminals for connecting to said USB storage card.

7. The electronic device according to claim 6 wherein said conducting terminal is a conducting piece or a conducting protrusion.

8. The electronic device according to claim 1 being a portable electronic device.

9. The electronic device according to claim 8 wherein said portable electronic device is a mobile phone, a palm computer, a notebook computer, a personal digital assistant, or a digital camera.

10. The electronic device according to claim 1 being a desktop computer.

11. The electronic device according to claim 1 wherein said containing space further comprises a fixing device for securing said USB storage card in said containing space.

12. The electronic device according to claim 1 wherein said electronic device further comprises a second connector for connecting to a smart card.

13. The electronic device according to claim 12 wherein said smart card is a SIM card.

14. An electronic device comprising:
a containing space; and
a USB storage card inserted in said containing space for storing files to said USB storage card or accessing files in said USB storage card.

15. The electronic device according to claim 14 being a portable electronic device.

16. The electronic device according to claim 14 being a desktop computer.

17. The electronic device according to claim 14 further comprising a connector disposed in said containing space for electrically coupling to said USB storage card.

18. The electronic device according to claim 17 wherein said USB storage card comprises at least a set of contact pad having a plurality of pins and said connector comprises a plurality of conducting terminals corresponding to said plurality of pins of said connector.
